(19) United States
(12) Patent Application Publication
(10) Pub. No.: US 2007/0256944 A1
(43) Pub. Date: Nov. 8, 2007

(54) Method and electrochemical sensing strip with screen-printed three electrodes for determining concentration of dissolved oxygen in a solution

(75) Inventors: Meng Shan Lin, Taipei County (TW); Hoang Jyh Leu, Taipei County (TW); Chien Hung Lai, Taipei County (TW)

Correspondence Address: BACON & THOMAS, PLLC, 625 SLATERS LANE, FOURTH FLOOR, ALEXANDRIA, VA, 22314, US

(73) Assignee: Tamkang University, Taipei County (TW)

(21) Appl. No.: 11/605,248

(22) Filed: Nov. 29, 2006

(30) Foreign Application Priority Data
Apr. 14, 2006 (TW) 95113403

(51) Int. Cl. G01F 1/64; G01N 27/26

(52) U.S. Cl. 205/782; 204/400

(57) ABSTRACT

A new electrochemical method for determining dissolved oxygen concentration is developed. It employs cobalt based oxide or complex to modify a conductive electrode surface. This method can be applied to determine dissolved oxygen in regard to medical and environmental demands. The chemical formula of the cobalt based oxide or complexes can be shown as CoₓO_{y} or CoₐL_{b}. Both “x” and “a” represent the number of cobalt atom; while “y” and “b” represent the number of oxygen atom and the number of coordinating ligand, respectively. For instance, the best known example of cobalt oxide is CO₃O₄, and the best known examples of cobalt complexes are cobalt phthalocyanine (CoPC) and cyanocobalamin (vitamin B₁₂), or other macrocyclic complexes with a metallic nucleus of cobalt. The present invention determines the concentration of dissolved oxygen in solution in potentiostatic mode with three electrodes. As a result, the dissolved oxygen can be determined between 0.0V and −0.3V vs. Ag/AgCl, thereby significantly reducing the interferences from the easily oxidized compounds in water solutions.

### FIELD OF THE INVENTION

The present invention is related to an electrochemical sensor that is used to measure the concentration of dissolved oxygen in a solution, and more particularly, to a siphon type electrochemical sensing strip with three screen-printed electrodes, which is adequate for measuring the concentration of dissolved oxygen in solutions of small volume, in addition to general measurements.

### BACKGROUND OF THE INVENTION

In regard to the measurement of chemical concentration carried out by using electrochemical sensors, the three-electrode system is mainly consisted of a working electrode, a reference electrode, and a counter electrode; the system is used in combination with the general electrochemical three-electrode potentiostat to carry out measurement and analysis. In the generally commercialized measuring systems, the working electrode can be made of materials like gold, platinum, glass carbon, mercury, and graphite; the reference electrode can be made of either saturated calomel electrode or silver/silver chloride (Ag/AgCl) electrode, and the counter electrode is usually made of platinum electrode.

When applying electrical potential, the potential applied to the working electrode is the working potential relative to the reference electrode, and the counter electrode is designed for assisting the applying potential to the working electrode; whereas the reference electrode itself provides a constant potential that does not change in response to various reaction currents. In comparison with the dual electrode system, the addition of a reference electrode in the three-electrode system not only effectively compensates the reduction of potential resulted from the IR drop, it also prevents the applied working potential from deviating or fluctuating, thereby improving the precision of the measurement.

The commercialized dissolved-oxygen probes sold on the current market generally carry out measurement by using the combination of dual electrode system and potential amperometry. In the design of the sensor, an inert electrode is directly used to measure the reduction signal of oxygen, and the front end of the electrode is covered with a thin film with a high selectivity that allows only oxygen dissolved in liquid to pass through, so that other interfering substances can be prevented from entering. However, such device must be placed in a constantly stirring system in order to allow the stable concentration of dissolved oxygen to be measured correctly. On the other hand, it is also necessary to regularly maintain and change the oxygen selective film, the surface of electrode, and the internal electrolyte solution, thus adding inconvenience to its operation, and the cost of the materials are also an additional burden to the users.

In the traditional electrochemical method for measuring dissolved oxygen concentration, it is necessary to cover a thin layer of air-permeable and oxygen-selective film over the electrode, which leads to longer response time. To solve this problem, a number of materials that can catalyze oxygen are developed. As the techniques for the modification of electrode continue to improve, many methods for modifying electrode are published gradually. In the paper published by B. W. Ng, R. Lenigk, Y. L. Wong, X. Wu, N. T. Yu, and R. Renneberg (B. W. Ng, R. Lenigk, Y. L. Wong, X. Wu, N. T. Yu, R. Renneberg, J. Electrochem. Soc., 2000, 147, 2350.), the sol-gel method was utilized to modify cobalt-containing porphyrin macrocyclic compound on the surface of platinum electrode. Moreover, in the work published by F. D. Souza, Y.-Y. Hsieh, H. Wickman, and W. Kutner (F. D. Souza, Y.-Y. Hsieh, H. Wickman, W. Kutner, Electroanalysis, 1997, 9, 1093.), the cyclodextrin derivatives were mixed with cobalt-containing porphyrin macrocyclic compound to prepare catalytic film on a gold electrode. The completed product was used to measure oxygen concentration in a solution directly, and it required only one minute of reaction time to complete the whole process of measuring dissolved-oxygen concentration.

For the development of electrochemical sensors, the size of the commercialized electrode used for sensing dissolved oxygen cannot be miniaturized readily. As a result, the cost of measurement by using commercialized electrode is comparatively higher, which cannot meet the goal of disposable sensor. In order to fulfill the goal of using disposable equipment for medical examination, and to avoid the mutual contamination resulted from environmental examination, the development of a disposable electrode in the form of sensing strip is more practical with regard to the demand of actual application. Furthermore, the screen-printed technique developed by the semi-conductor industry has already matured and can be employed to fabricate electrodes at a cost-effective way, as well as to elevate the productivity of fabricating disposable electrodes per unit time. Therefore, the three-electrode system proposed in the present invention apparently has more tangible economical benefits in comparison to the conventional commercialized electrochemical three-electrode system, its advantages can meet the developmental trend of the future and should be worthy of more vigorous promotion and wider application.

In U.S. Pat. No. 6,042,714 one of the inventors of the present invention and his co-workers disclose a new chemical sensor to monitor H₂O₂ concentration in a liquid. The H₂O₂ chemical sensor includes a transducer which is able to conduct an electric current and a mixed-valence compound deposited on a surface of the transducer. The mixed-valence compound has a formula as follows:
M_{y}^{Z+}[Fe(II)(CN)₆]
where M can be Co, Ni, Cr, Sc, V, Cu, Mn, Ag, Eu, Cd, Zn, Ru, or Rh; z is the valence of M; and y=4/z. This prior art invention also reveals a chemical sensor to monitor a concentration of a H₂O₂ precursor. The H₂O₂ precursor is defined as a compound that can produce H₂O₂ in said liquid under appropriate reaction conditions. The H₂O₂ precursor chemical sensor contains the transducer, and a composition deposited on a surface of the transducer. The composition comprises the mixed-valence compound and a catalyst capable of catalyzing the reaction. This prior art invention uses a fixed potential ranging from +0.1 V to −0.2V between the working electrode and a reference electrode of 3 M KCl Ag/AgCl to catalyze the reduction of hydrogen peroxide, so that the concentration of hydrogen peroxide is measured. As a result, the transducer modified by the mixed-valence compound is able to monitor the H₂O₂ concentration at a potential which will not be interfered by other undesirable biochemical compounds in blood (such as ascorbic acid, uric acid, dopamine, cysteine and acetaminophen, etc.). Furthermore, by adding proper electrolyte and pH buffer, the interference from oxygen (a strong reducible compound, may cause reductive current) is also prevented. The disclosure of U.S. Pat. No. 6,042,714 is incorporated herein by reference.

In US patent application publication No. 2005-0189240 A1, one of the inventors of the present invention and his co-workers disclose a new chemical sensor to monitor H₂O₂ concentration in a liquid. A chemical sensor disclosed in this US patent application comprises a transducer which is able to conduct an electric current and a mixed-valence metal oxide deposited on a surface of the transducer, wherein said mixed-valence metal oxide has a formula as follows:
MₓO_{y}
wherein M is a transition metal and has two or more than two different valences; x and y represent moles of said transition metal, M, and oxygen, respectively, provided that 2y=(x₁)(z₁)+(x₂)(Z₂) . . . +(xₙ)(zₙ), and x₁+x₂+ . . . +xₙ=x, wherein z₁, z₂, . . . zₙ represent the valences of M; x₁, x₂, xₙ represent moles of M having valences of z₁, z₂, . . . zₙ, respectively, and n is a positive integer. The disclosure of US application publication No. 2005-0189240 A1 is incorporated herein by reference.

### SUMMARY OF THE INVENTION

The invention of the present application uses a cobalt based oxide or complex to develop a chemical sensor for measuring a concentration of dissolved oxygen in environmental detection and medical tests. With the help of the technique of electrode surface modification, it is possible that the cobalt based oxide or complex of this invention can be deposited on the surface of the working electrode in the three-electrode system, which is then able to be used for measuring dissolved oxygen concentration. The new chemical sensor derived from this invention is able to measure dissolved oxygen concentration at a relatively low potential which will prevent the measurement from being interfered by other undesirable compounds in the solution. Furthermore, in order to solve the problem of sampling with regard to electrochemical determination, the screen-printing technique is employed to miniaturize the sensing platform. On the other hand, a siphon type electrochemical sensing strip is combined into the platform in order to meet the demand of developing a portable sensor, so that a sensing system that is fast, stable, cost-effective, and with low interference as well as high sensitivity can be achieved. Such a system can be readily used to measure dissolved oxygen in various biomedical and environmental applications.

The cobalt based oxide or complexes are formed by coordinating binds and thus are stable chemicals. Further, the cobalt based oxide or complexes have an advantage of a good electron transfer capability, which makes them suitable for the preparation of the chemical sensor. The cobalt based oxide or complexes are not easy to be affected by humidity and temperature; and are low in price and easy availability, which make the chemical sensor of the present invention more feasible to be commercialized. Furthermore, by incorporating with a proper enzyme, a biosensor can be prepared by using the cobalt based oxide or complexes of the present invention.

### BRIEF DESCRIPTION OF THE DRAWINGS

FIG. 1 is a schematic plan view showing that wires are printed on a substrate when fabricating a siphon type screen-printed three-electrode sensing strip of the present invention.

FIG. 2 is a schematic plan view showing that the reference electrode and the working electrode are printed on the substrate shown in FIG. 1.

FIG. 3 is a schematic plan view illustrating that the insulating layer is adhered on the substrate shown in FIG. 2.

FIG. 4 is a schematic plan view showing that an upper covering film is adhered on the substrate shown in FIG. 3.

FIG. 5 shows a calibration curve of a working electrode upon successive injections of a dissolved oxygen solution to provide increments in dissolved oxygen concentration in an amperometric analysis, where the x-axis is the concentration of dissolved oxygen (mM), and the y-axis is reductive current (μA). The working electrode is a chemical sensor containing CO₃O₄ prepared according to Example 1 of the present invention.

FIG. 6 shows a calibration curve of a working electrode upon successive injections of a dissolved oxygen solution to provide increments in dissolved oxygen concentration in an amperometric analysis, where the x-axis is the concentration of dissolved oxygen (mM), and the y-axis is reductive current (μA). The working electrode is a chemical sensor containing cyanocobalamin complex prepared according to Example 2 of the present invention.

FIG. 7 shows a calibration curve of a working electrode upon successive injections of a dissolved oxygen solution to provide increments in dissolved oxygen concentration in an amperometric analysis, where the x-axis is the concentration of dissolved oxygen (mM), and the y-axis is reductive current (μA). The working electrode is a chemical sensor containing cobalt phthalocyanine prepared according to Example 3 of the present invention.

### DETAILED DESCRIPTION OF THE INVENTION

Novel chemical sensors designed to measure concentrations of dissolved oxygen are provided in the present invention. The novel chemical sensors comprise the cobalt based oxide or complexes deposited on a surface of a transducer, for example, an electrochemical electrode. The cobalt based oxide or complexes provide the chemical sensors with electrode assisted catalysis in an amperometric measurement of dissolved oxygen concentration in a given solution, wherein the chemical sensor is used as a working electrode.

In the present invention, the cobalt based oxide or complexes deposited on the transducer with a catalysis characteristic of reduction are compounds formed by metallic nuclei of cobalt bound to oxygen atoms or metallic nucleus of cobalt coordinated to ligand. The metallic nuclei of cobalt oxide have their own valences, and electrons within the metallic nuclei are in the delocalization state. An electron transferring route is formed through the inter-valence charge transfer characteristic of the metallic nuclei of cobalt after coordination, so that the cobalt based oxide, in an amperometric measurement of oxygen, can accomplish charge transfer and catalysis of the reduction of oxygen. On the other hand, the metallic nucleus of cobalt complexes also has its own valence charge, and the electron within the cobalt atom can be transfer through measurement species of oxygen. An electron transferring route is formed through the central of cobalt complex, so that it can accomplish charge transfer and catalysis of the reduction oxygen by amperometric measurement.

In the present invention, the chemical formula of the cobalt oxide can be shown as CoₓO_{y}. In the formula, the “x” represents the number of cobalt atom; while “y” represents the number of oxygen atom. The best known examples of cobalt oxide is cobalt(III,II,III) oxide, which can be abbreviated as CO₃O₄.

In addition, the chemical formula of the cobalt based complex can be shown as CoₐL_{b}. In the formula, the “a” represents the number of cobalt atom; while “b” represents the number of coordinating ligand. The best known examples of cobalt complex are cobalt(II) phthalocyanine, which can be abbreviated as CoPC; as well as cyanocobalamin (also known as vitamin B₁₂), or other macrocyclic complexes with a metallic nucleus of cobalt.

When an electrode modified with the cobalt based oxide or complex is used as a working electrode in an amperometric measurement of dissolved O₂, the cobalt based oxide or complex is oxidized from a reduction state to an oxidation state by O₂, and creates an electronic hole therein. The electronic hole is then transferred to the transducer via the inter-valence charge transfer characteristic of the cobalt based oxide or complex, so that a current loop is formed, and a signal in response to dissolved O₂ concentration is obtained with a smaller reduction potential being applied.

The dissolved O₂ chemical sensor of the present invention has a fast response time (t_{90%}), a broad linear range of concentration vs. current, and a high sensitivity, when it is used as a working electrode in an amperometric measurement of dissolved O₂ concentration in a given solution and when the reduction potential of the chemical sensor is at 0 to −0.3V (vs. 3 M KCl Ag/AgCl reference electrode). The new chemical sensors derived from this invention are able to monitor the dissolved O₂ concentration at a potential which will not be interfered by heavy-metal containing compounds and other easily oxidizable compounds in the solutions to be measured. Furthermore, by adding proper electrolyte and pH buffer the interference from other environmental substances is also reduced. The interferences from the ordinary heavy-metal containing compounds include those containing Cu²⁺, Cr³⁺, Cd²⁺, Fe²⁺ and Co²⁺; and ordinary organic compounds in the environment such as camphor, humic acid, and p-nitrophenol, are not seen in an amperometric measurement of dissolved O₂ concentration by using the chemical sensors of the present invention.

The cobalt based oxide or complex in this invention has low solubility in water and high chemical stability, and thus it can be applied to interfacial chemistry of electrochemical analysis. The preparation of the dissolved O₂ chemical sensor of the present invention is simple. For example, the cobalt based oxide (such as CO₃O₄) or complex (such as Co(PC)) can be mixed with an electrical conductive ink in an appropriate ratio, and depositing the resulting mixture on a surface of an electrode by coating, chemical modification, sputtering or chemical vapor deposition to form a thick film electrode, which is ready for use when the ink is dry. For the cobalt based complexes which are water soluble, such as cyanocobalamin, the electrode can be modified by using the graphite component in a conductive ink to adsorb cobalt based complex and then encapsulated with a polymeric material.

When a solid electrode is used to carry out electrochemical measurement for the dissolved oxygen in a solution, the solution must be stirred at a constant speed to make it become homogeneous, so that the measuring process can proceed; otherwise the sheer volume of the solution could interfere with this process. However, in another viable mode of the present invention, a large quantity of sensing strip for dissolved oxygen can be produced by using the screen-printed electrodes. By mixing the cobalt based oxide or complex with conductive ink, then carrying out electrode modification on the surface of a transducer of the working electrode with a design template, a miniaturized electrochemical sensing strip can be produced. The electrode can be further coupled with the design of sampling by siphon action, so that the sampling and measuring processes can be readily achieved even if the volume of the solution to be sampled is small. The device can also effectively stop the oxygen of the surrounding atmosphere from entering the sample, thereby preventing the sample from getting affected and resulting in false readings. As a result, the electrochemical dissolved-oxygen probe is capable of determining the amount of dissolved oxygen in a sample. When the surface area of the working electrode of the electrochemical sensor is shrunken to the extent at which its current signal is not affected by the actual potential reduction caused by the solution to be determined, the reference electrode can also be omitted.

The siphon type screen-printed three-electrode electrochemical sensing strip of the present invention comprises:

1. A substrate to be used for screen printing, which can be a variety of white plastic or synthetic paper made of plastic, wherein the plastic materials can be PP (polypropylene), PE (polyethylene), PVC (polyvinyl chloride), and PET (polyethylene terephthalate); its thickness is between 0.1 mm to 2 mm, and can be used for printing on various carriers.

2. The counter electrode and the conductive parts of the electrode wires, which can be conductive ink that contains carbon, gold, silver, and platinum; printing is carried out directly on the substrate described above in combination with screens and steel plates, there is no need to print conductive materials on the substrate to increase its conductivity.

3. The reference electrode, which can be conductive ink that contains silver or silver/silver chloride; printing can be carried out on the conductive part of the electrode wire described above, and can also be carried out directly on the substrate described above in combination with screens and steel plates, there is no need to print conductive materials on the substrates to increase its conductivity.

4. The working electrode, which can be conductive ink that contains carbon, gold, silver, platinum, and mixed with cobalt based oxide or complexes; a working area can be printed on the terminal of the conductive part of the electrode wire described above, and steel plates or screens should be used during its preparation.

5. An insulating layer, which is either an ink without conductivity or a non-conductive adhesive, it can be prepared by the screen printing method, then dried by the heating method as well as the UV radiation cross-linking method, or by using the double-sided adhesive tape as a replacement, the purpose is to prevent the wires from contacting the solution to be determined, and to form a reaction zone with an upper covering film.

6. An upper covering film, which is mainly composed of a polymer. It is attached to the substrate in order to cover the insulating layer, and an adequate through hole is created on the upper covering film to restrict the height of the liquid and to promote the liquid that is rapidly sucked into the reaction zone, that is the gap between the surface of the substrate that has not been covered with the insulating layer and the upper covering film. The gap is able to draw the liquid to be measured to contact the electrodes by capillary/siphon action, and the through hole on the upper covering film is within the gap area above the gap.

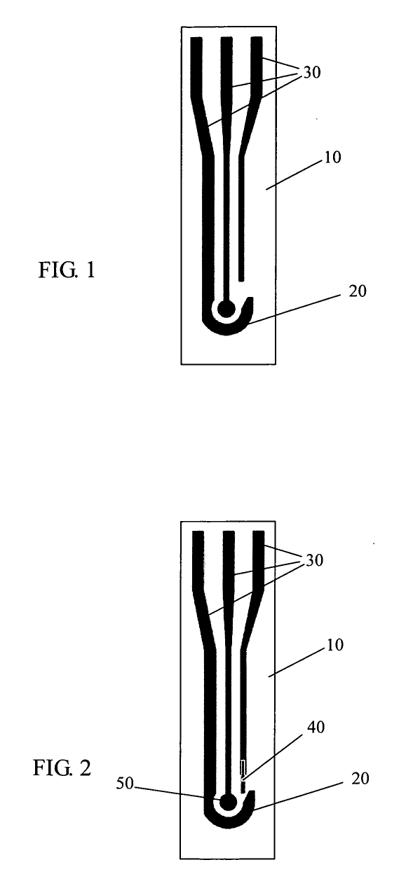

An adequate method for fabricating the siphon type screen-printed three-electrode sensing strip of the present invention in the laboratory, as shown in FIGS. 1 to 4, comprises the following steps:

1. Substrate 10, which is a type of synthetic paper; is cut into adequate size (for the testing strip, the length is 4.5 cm, and the width is 1 cm), then it is moved to the carrier for printing.

2. Wires 30 are printed for each of the three electrodes on the substrate, which are the reference electrode, the working electrode, and the counter electrode from right to left, respectively; this is followed by heating at 40° C. to 50° C. for 40 minutes, in which the arc-shaped terminal of the leftmost wire is made into a counter electrode 20, as indicated in FIG. 1.

3. Reference electrode 40 is printed on the substrate, the area of the electrode does not need to be large, and a portion of the electrode has to overlap with the terminal portion of the rightmost wire, which is one of the three wires printed beforehand, followed by heating at 40° C. to 50° C. for 40 minutes, as indicated in FIG. 2.

4. Working electrode 50 is printed on the substrate, the ink used for printing must be evenly mixed with the catalyst prior to printing, and the printed portion must completely overlap with the circular terminal portion of the middle wire, which is one of the three wires printed beforehand, followed by heating at 30° C. to 40° C. for 40 minutes, as indicated in FIG. 2.

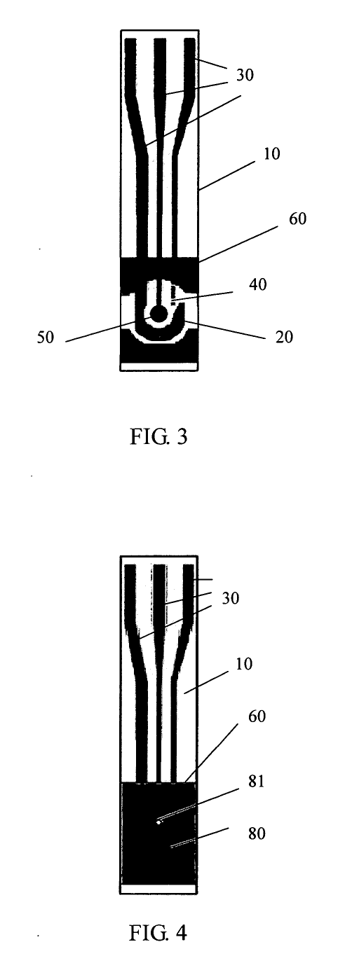

5. A suitable mechanical mold is used to die cut a double-sided adhesive tape into an adequate shape (the thickness of the tape is 15 μm), then the tape is aligned to the substrate and attached onto it; followed by the removal of the releasing paper to obtain insulating layer 60. The insulating layer 60 covers the middle section of the three wires, so that the two ends of the three wires are separated. The insulating layer further covers the base of the arc-shaped counter electrode 20 and thereby forming a reaction zone in which the counter electrode 20, working electrode 50, and reference electrode 40 are situated, as well as forming two passages that are at both sides of the reaction zone, as indicated in FIG. 3.

6. As indicated in FIG. 4, a polymer upper covering film 80 with an through hole 81 (its diameter is 0.5 mm) is aligned and then attached to insulating layer 60 on substrate 10; the insulating layer 60 is formed by using a double-sided adhesive tape. A capillary/siphon action area is formed between the upper covering film 80 and the surface of the substrate 10. Through hole 81 on the upper covering film is located at a position slightly higher than the working electrode 50 in order to promote the liquid sample flow and to limit the area of contact between the solution to be measured and the working electrode, so that the rate of change engendered from the measuring process can be reduced.

For the siphon type screen-printed three-electrode sensing strip shown in FIGS. 1 to 4, the areas of the electrodes are: working electrode, 1.78 mm²; reference electrode, 1.5 mm²; and counter electrode, larger than 6 mm². The volume of liquid drawn into the space between the upper covering film 80 and the surface of the substrate 10 that is not covered by the insulating layer 60 is 10 μL measured by using pure water.

The invention will be further illustrated by the following examples. The following examples are only meant to illustrate the invention, but not to limit it.

### EXAMPLE 1

### Chemical Sensor Based on Co₃O₄

(1). Pretreatment of Electrode

A rotating disk graphite electrode was polished using 0.1 μm Al₂O₃ suspension, and sonicated for three minutes in deionized water. The procedures were repeated once. The electrode surface was then rinsed with deionized water twice. Finally, the electrode surface was checked by a cyclic voltammetry (BAS 100W, Bioanalytical Systems) to ensure free of contamination.

(2). Preparation of a Working Electrode

A mixture having 50% of Co₃O₄ was prepared by well mixing CO₃O₄ and electrically conductive ink, which was then diluted with cyclohexanone to obtain a viscosity suitable for coating (the amount of cyclohexanone added was about equal to the mixture). The pretreated rotating disk graphite electrode was coated with the resulting Co₃O₄ mixture, and dried at 40° C. for 20 minutes.

(3). Measurement Conditions

The working electrode prepared above, a homemade 3M KCl Ag/AgCl reference electrode, and a platinum wire counter electrode were immersed in a 0.05 M, pH=8, phosphate buffer, with 0.15 M NaCl solution to improve conductivity in an electrochemical cell. A bi-potentiostat (model PAR, 366A, Princeton Applied Research) was used to control the applied voltage at −300 mV (vs. Ag/AgCl). The detection temperature of the electrochemical cell was kept at 25° C. with a circulator (Model B402, Firstek Scientific). The phosphate buffer in the cell was stirred constantly at 625 rpm with a motor controlled rotor (Model 636, Princeton Applied Research).

Saturated dissolved O₂ solution was added to the phosphate buffer in the cell at a constant time interval to provide an increment in dissolved O₂ concentration so that steady-state amperometric measurements of dissolved oxygen concentration were conducted.

(4). Results

After the successive injections of saturated dissolved O₂ solution to the cell, the electric current response versus time is used to establish a correlation curve of the chemical sensor prepared.

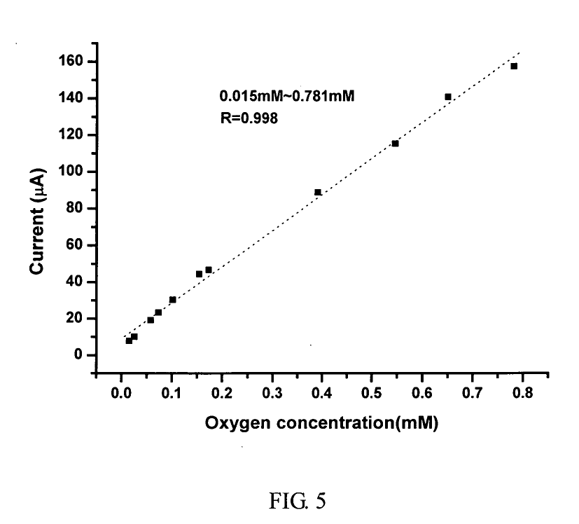

By plotting dissolved O₂ concentration vs. current (μA), it was found that there was a linear relationship within a range from 0.015 mM to 0.781 mM (correlation coefficient=0.998). A slope of 1.002 mA/mM-cm² was obtained using the least square method, as shown in FIG. 5.

The response time that between 10% and 90% of the maximum signal (t_{90%}) was 3.0 seconds (not shown in the drawing). The measurement was repeated for 17 times using 0.25 mM dissolved O₂ solution, and a relative standard deviation of 3.5% was observed. Based on the signal-to-noise characteristics (S/N=3), it was found that the detection limit of dissolved O₂ was 0.34 μM.

Further interference experiments indicated there was no substantial interference when measuring 0.25 mM dissolved O₂ solution separately in the presence of 100 μM of Cu²⁺, Cr³⁺, Cd²⁺, Fe²⁺, Co²⁺, camphor and p-nitrophenol; and 100 ppm of humic acid.

### EXAMPLE 2

### Chemical Sensor Based on Cyanocobalamin (Vitamin B₁₂)

(1). Pretreatment of Electrode

A rotating disk graphite electrode was polished using 0.1 μm Al₂O₃ suspension, and sonicated for three minutes in deionized water. The procedures were repeated once. The electrode surface was then rinsed with deionized water twice. Finally, the electrode surface was checked by a cyclic voltammetry (BAS 100W, Bioanalytical Systems) to ensure free of contamination.

(2). Preparation of a Working Electrode

A mixture having 15 parts by weight of cyanocobalamin and 45 parts by weight of electrically conductive ink was prepared, and was then diluted with 40 parts by weight of cyclohexanone to obtain a viscosity suitable for coating. The pretreated rotating disk graphite electrode was coated with 3 μL of the resulting cyanocobalamin mixture, and dried at 25° C. for 30 minutes, followed by immersing in 0.05 M phosphate buffer (pH=6) for 25 minutes for stabilization while stirring at 625 rpm.

(3). Measurement Conditions

The working electrode prepared above, a homemade 3M KCl Ag/AgCl reference electrode, and a platinum wire counter electrode were immersed in a 0.05 M, pH=3, acetate buffer, with 0.1 M NaCl solution to improve conductivity in an electrochemical cell. A bi-potentiostat (model PAR, 366A, Princeton Applied Research) was used to control the applied voltage at −200 mV (vs. Ag/AgCl). The detection temperature of the electrochemical cell was kept at 25° C. with a circulator (Model B402, Firstek Scientific). The acetate buffer in the cell was stirred constantly at 900 rpm with a motor controlled rotor (Model 636, Princeton Applied Research).

Saturated dissolved O₂ solution was added to the acetate buffer in the cell at a constant time interval to provide an increment in dissolved O₂ concentration so that steady-state amperometric measurements of dissolved oxygen concentration were conducted.

(4). Results

After the successive injections of saturated dissolved O₂ solution to the cell, the electric current response versus time is used to establish a correlation curve of the chemical sensor prepared.

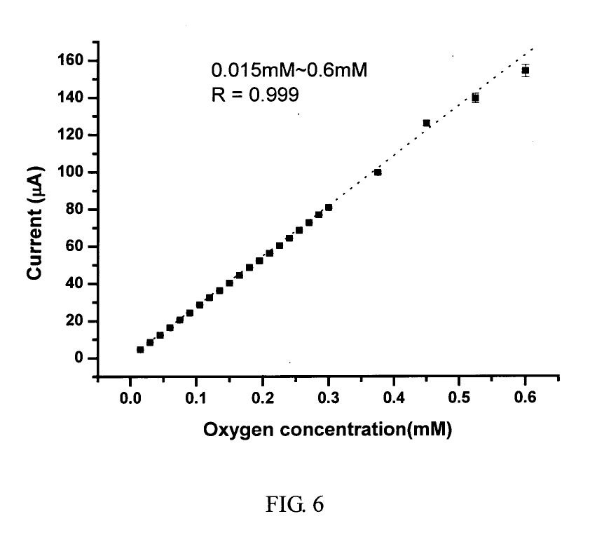

By plotting dissolved O₂ concentration vs. current (μA), it was found that there was a linear relationship within a range from 0.015 mM to 0.6 mM (correlation coefficient=0.999). A slope of 1.369 mA/mM-cm² was obtained using the least square method, as shown in FIG. 6.

The response time that between 10% and 90% of the maximum signal (t_{90%}) was 8.8 seconds (not shown in the drawing). The measurement was repeated for 20 times using 0.25 mM dissolved O₂ solution, and a relative standard deviation of 1.37% was observed. Based on the signal-to-noise characteristics (S/N=3), it was found that the detection limit of dissolved O₂ was 9.2 μM.

Further interference experiments indicated there was no substantial interference when measuring 0.25 mM dissolved O₂ solution in the presence of 100 μM of Cu²⁺, Cr³⁺, Cd²⁺, Fe²⁺, Co²⁺, camphor and p-nitrophenol; and 100 ppm of humic acid, separately.

### EXAMPLE 3

### Chemical Sensor Based on Cobalt (II) Phthalocyanine

(1). Pretreatment of Electrode

A rotating disk graphite electrode was polished using 0.1 μm Al₂O₃ suspension, and sonicated for three minutes in deionized water. The procedures were repeated once. The electrode surface was then rinsed with deionized water twice. Finally, the electrode surface was checked by a cyclic voltammetry (BAS 100W, Bioanalytical Systems) to ensure free of contamination.

(2). Preparation of a Working Electrode

A mixture having 20% of cobalt (II) phthalocyanine was prepared by well mixing cobalt (II) phthalocyanine and electrically conductive ink, which was then diluted with cyclohexanone to obtain a viscosity suitable for coating (the amount of cyclohexanone added was about equal to the mixture). The pretreated rotating disk graphite electrode was coated with the resulting cobalt (II) phthalocyanine mixture, and dried at 30° C. for 30 minutes.

(3). Measurement Conditions

The working electrode prepared above, a homemade 3M KCl Ag/AgCl reference electrode, and a platinum wire counter electrode were immersed in a 0.05 M, pH=8, phosphate buffer, with 0.15 M NaCl solution to improve conductivity in an electrochemical cell. A bi-potentiostat (model PAR, 366A, Princeton Applied Research) was used to control the applied voltage at −300 mV (vs. Ag/AgCl). The detection temperature of the electrochemical cell was kept at 25° C. with a circulator (Model B402, Firstek Scientific). The phosphate buffer in the cell was stirred constantly at 625 rpm with a motor controlled rotor (Model 636, Princeton Applied Research).

Saturated dissolved O₂ solution was added to the phosphate buffer in the cell at a constant time interval to provide an increment in dissolved O₂ concentration so that steady-state amperometric measurements of dissolved oxygen concentration were conducted.

(4). Results

After the successive injections of saturated dissolved O₂ solution to the cell, the electric current response versus time is used to establish a correlation curve of the chemical sensor prepared.

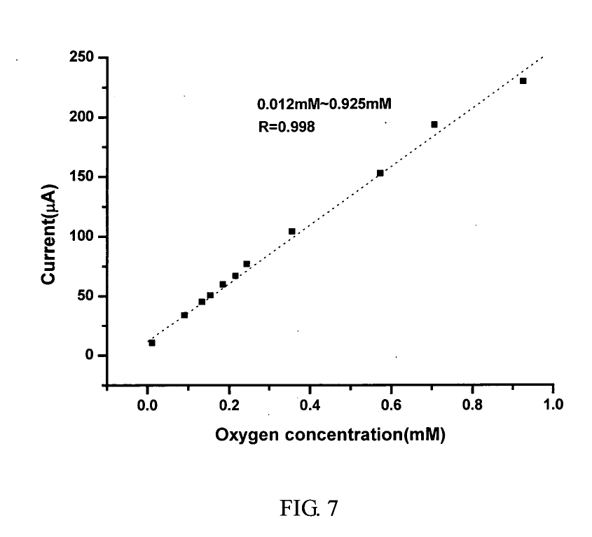

By plotting dissolved O₂ concentration vs. current (μA), it was found that there was a linear relationship within a range from 0.012 mM to 0.925 mM (correlation coefficient=0.998). A slope of 1.235 mA/mM-cm² was obtained using the least square method, as shown in FIG. 7.

The response time that between 10% and 90% of the maximum signal (t₉₀%) was 2.2 seconds (not shown in the drawing). The measurement was repeated for 20 times using 0.25 mM dissolved O₂ solution, and a relative standard deviation of 3.1% was observed. Based on the signal-to-noise characteristics (S/N=3), it was found that the detection limit of dissolved O₂ was 0.5 μM.

Further interference experiments indicated there was no substantial interference when measuring 0.25 mM dissolved O₂ solution separately in the presence of 100 μM of Cu²⁺, Cr³⁺, Cd²⁺, Fe²⁺, Co²⁺, camphor and p-nitrophenol; and 100 ppm of humic acid.

An electrochemical method for determining a concentration of dissolved oxygen in a solution utilizing screen-printed electrodes is applicable in view of Examples disclosed above. Employing the cobalt based oxide or complexes described above to prepare a sensing strip with screen-printed electrodes and then use it for measurement will be described in the following:

(1) Utilizing the technique of screen printing to prepare the three-electrode system on a substrate that is flat and oxygen impermeable, which comprises a working electrode (a conductive ink mixed with cobalt based oxide or complexes), a reference electrode (an ink containing Ag/AgCl), and a counter electrode (the main ingredient is conductive carbon paste).

(2) The printed substrate from the previous step is further processed and packaged as described above and shown in FIGS. 1 to 4. The resulting sensing strip has a siphon sampling design and the sampling volume is about 10 μL. The siphon design can effectively stop the oxygen of the surrounding atmosphere when the solution is sampled, thereby preventing the sample from getting affected and resulting in false readings, as a result, the electrochemical dissolved-oxygen sensing strip is capable of measuring the concentration of dissolved oxygen in real time.

(3) The sensing strip contacts a solution to begin the measurement, the solution is drawn into the reaction zone through the passages immediately, readily fills the reaction zone, and contact the electrodes therein. The volume of the solution sampled is about 10 μL.

(4) After sampling, the measurement of the sampled solution is accomplished by chronoamperometry with a three-electrode meter, and an instant current is obtained from the three-electrode meter;

(5) The instant current obtained in the previous step is further compared to the current values derived from liquid samples of known dissolved-oxygen concentrations, and then the dissolved-oxygen concentration of the solution sampled can be calculated. The current values of the liquid samples of known dissolved-oxygen concentrations have been determined by using the same measuring method.

1. A method for measuring dissolved oxygen concentration in a solution comprising the following steps:
a) contacting a counter electrode, a reference electrode and a working electrode with a solution, wherein said working electrode comprises a transducer which is able to conduct an electric current and a cobalt based oxide having a chemical formula of Co_{X}O_{y} or complex having a chemical formula of CoₐL_{b} deposited on a surface of the transducer, wherein x represents moles of cobalt atom in the oxide, y represents moles of oxygen atom in the oxide, L represents a coordinating ligand in the complex, a represents moles of cobalt atom in the complex, and b represents moles of the coordinating ligand, L, in the complex;
b) obtaining an electric current from the working electrode by amperometry, wherein a fixed potential between the working electrode and the reference electrode is maintained, and said fixed potential ranges from 0.0 V to −0.30 V when the reference electrode is 3 M KCl Ag/AgCl electrode; and
c) comparing the electric current from b) with electric currents obtained from solutions having known dissolved oxygen concentrations under substantially the same operating conditions and the same fixed potential used in steps a) and b), so that a concentration of dissolved oxygen in said solution is calculated from said comparison.

2. The method of claim 1, wherein the cobalt based oxide having a chemical formula of CO₃O₄ is deposited on the surface of the transducer.

3. The method of claim 1, wherein the cobalt based complex is deposited on the surface of the transducer, and the cobalt based complex is cobalt phthalocyanine or cyanocobalamin.

4. The method of claim 1, wherein step a) further comprises maintaining the solution in a homogeneous phase by stirring, adding an electrolyte to the solution, and maintaining a substantially constant pH by adding a pH-buffer.

5. The method of claim 4, wherein said pH-buffer is phosphate buffer or acetate buffer, and said electrolyte is an alkali metal halide.

6. The method of claim 5, wherein the cobalt based oxide having a chemical formula of Co₃O₄ is deposited on the surface of the transducer, said pH-buffer is phosphate buffer having a pH of 8, and said electrolyte is NaCl or KCl.

7. The method of claim 6, wherein the reference electrode comprises 3 M KCl Ag/AgCl, and said fixed potential is about −300 mV.

8. The method of claim 5, wherein the cobalt based complex is deposited on the surface of the transducer, said pH-buffer is acetate buffer having a pH of 3, and said electrolyte is NaCl, wherein the cobalt based complex is cyanocobalamin complex.

9. The method of claim 8, wherein the reference electrode comprises 3 M KCl Ag/AgCl, and said fixed potential is about −200 mV.

10. The method of claim 5, wherein the cobalt based complex is deposited on the surface of the transducer, said pH-buffer is phosphate buffer having a pH of 8, said electrolyte is NaCl, wherein the cobalt based complex is cobalt phthalocyanine.

11. The method of claim 10, wherein the reference electrode comprises 3 M KCl Ag/AgCl, and said fixed potential is about −300 mV.

12. The method of claim 1, wherein the electric current is a steady electric current or an instant electric current.

13. A siphon type electrochemical quantitative sensing strip having screen-printed three electrodes, comprising:
a substrate;
patterned wires attached to a surface of the substrate, which comprises three wires that are separated from one another; one ends of the three wires are adapted to be connected to a electrochemical analyzer, while the other ends of the three wires are deposited with a counter electrode, a working electrode, and a reference electrode, respectively, wherein the counter electrode is in the form of an arc for forming an evenly distributed electric field; the working electrode is located at a position that is near a center of the arc, and the reference electrode is located at a perimeter of the arc and near the working electrode;
an insulating layer, which is adhered to the surface of the substrate, wherein an upper part of the insulating layer covers the middle section of the three wires, so that the two ends of the three wires are separated by the upper part, and a lower part of the insulating layer covers a surrounding area around a base of the arc-shaped counter electrode, thus forming a reaction zone in which the counter electrode, the working electrode, and the reference electrode are situated, as well as passages that are located at both sides of the reaction zone; and
an upper covering film that is adhered to the top of the insulating layer and covers the reaction zone, so that a gap is formed between the covering film and the surface of the substrate which is not covered by the insulating layer; the upper covering film being provided with a through hole which is near the working electrode and opposite to the wire that is deposited with the working electrode, the through hole having a function of limiting liquid volume, so that a solution that comes into contact with the gap will be drawn into the reaction zone by capillary action or siphon action and fills up the gap to a position of the through hole; wherein
the working electrode comprises a cobalt oxide having a chemical formula of CoₓO_{y} or a cobalt complex having a chemical formula Of CoₐL_{b}, wherein x represents the mole of cobalt atom and y represents the mole of oxygen atom in the cobalt oxide; L is a coordinating ligand, a represents the mole of cobalt atom, and b represents the mole of coordinating ligand of the cobalt complex; and
the reference electrode comprises silver or silver/silver chloride.

14. The sensing strip of claim 13, wherein the substrate is a polymer material that is non-conductive and impermeable to oxygen.

15. The sensing strip of claim 14, wherein the substrate is polyethylene, polypropylene, polyvinylchloride, polyethylene terephthalate, a copolymer thereof or a blend thereof.

16. The sensing strip of claim 13, wherein the three wires are printed on the substrate by using a conductive ink; among the three wires, the other end of the leftmost wire has an arc to serve as the counter electrode.

17. The sensing strip of claim 16, wherein the conductive ink comprises carbon, gold, silver, or platinum.

18. The sensing strip of claim 13, wherein the reference electrode is printed onto the other end of the rightmost wire among the three wires on the substrate by using a conductive ink comprises silver or silver/silver chloride.

19. The sensing strip of claim 13, wherein the working electrode is printed onto the other end of the middle wire among the three wires on the substrate by using a conductive ink comprising the cobalt oxide or cobalt complex, wherein the other end of the middle wire has an enlarged circular spot.

20. The sensing strip of claim 13, wherein the insulating layer is formed by using an adhesive that is non-conductive and impermeable to oxygen, or a double-sided adhesive tape adhered to the surface of the substrate.

21. The sensing strip of claim 13, wherein the working electrode comprises the cobalt oxide having a chemical formula of CO₃O₄.

22. The sensing strip of claim 13, wherein the working electrode comprises the cobalt based complex, and the cobalt based complex is cobalt phthalocyanine or cyanocobalamin.

23. The sensing strip of claim 13, wherein the upper covering film is made of a polymer material that is non-conductive and impermeable to oxygen.
